(19) United States
(12) Patent Application Publication
(10) Pub. No.: US 2025/0334485 A1
(43) Pub. Date: Oct. 30, 2025

(54) INFORMATION PROCESSING APPARATUS AND OPERATING METHOD OF INFORMATION PROCESSING APPARATUS

(71) Applicant: TOYOTA JIDOSHA KABUSHIKI KAISHA, Toyota-shi (JP)

(72) Inventors: Liang GONG, Minato-ku (JP); Yuta OKABE, Koganei-shi (JP); Shingo NIIYAMA, Hachioji-shi (JP); Ryuichi DANNO, Kasugai-shi (JP)

(73) Assignee: TOYOTA JIDOSHA KABUSHIKI KAISHA, Toyota-shi (JP)

(21) Appl. No.: 19/092,313

(22) Filed: Mar. 27, 2025

(30) Foreign Application Priority Data
Apr. 24, 2024 (JP) 2024-070931

(51) Int. Cl. G01M 17/007; G07C 5/08

(52) U.S. Cl. CPC G01M 17/007; G07C 5/08

(57) ABSTRACT

An information processing apparatus includes an acquisition interface configured to acquire information on a number of times an operation has been performed by a user on equipment of a vehicle for a test drive, and a controller configured to select first equipment having a predetermined difference between the number of times the operation has been performed and a reference value, and output first question information with respect to the first equipment.

### CROSS-REFERENCE TO RELATED APPLICATION

This application claims priority to Japanese Patent Application No. 2024-070931, filed on Apr. 24, 2024, the entire contents of which are incorporated herein by reference.

### TECHNICAL FIELD

The present disclosure relates to an information processing apparatus and an operating method of an information processing apparatus.

### BACKGROUND

In the development and sales of vehicles, the feedback and other reactions of users who have test-driven vehicles are used to improve products. Various technologies have been proposed to support the collection of such responses from users. For example, Patent Literature (PTL) 1 discloses technology for distributing questionnaires to vehicle users.

### CITATION LIST

### Patent Literature

PTL 1: JP 2010-277583 A

### SUMMARY

There is room to more effectively collect responses from users who have test-driven vehicles.

The following discloses an information processing apparatus and the like that enable more effective response collection from users who have test-driven vehicles.

An information processing apparatus in the present disclosure includes: an acquisition interface configured to acquire information on a number of times an operation has been performed by a user on equipment of a vehicle for a test drive; and a controller configured to select first equipment having a predetermined difference between the number of times the operation has been performed and a reference value, and output first question information with respect to the first equipment.

An operating method of an information processing apparatus in the present disclosure including:
acquiring information on a number of times an operation has been performed by a user on equipment of a vehicle for a test drive; and
selecting first equipment having a predetermined difference between the number of times the operation has been performed and a reference value, and outputting first question information with respect to the first equipment.

According to the information processing apparatus and the like in the present disclosure, it is possible to more effectively collect responses from users who have test-driven vehicles.

### BRIEF DESCRIPTION OF THE DRAWINGS

In the accompanying drawings:

FIG. 1 is a diagram illustrating an example configuration of an information communication system;

FIG. 2 is a sequence diagram illustrating an example operation procedure of the information communication system; and

FIG. 3 is a flowchart illustrating an example operation procedure of an information processing apparatus.

### DETAILED DESCRIPTION

An embodiment will be described below.

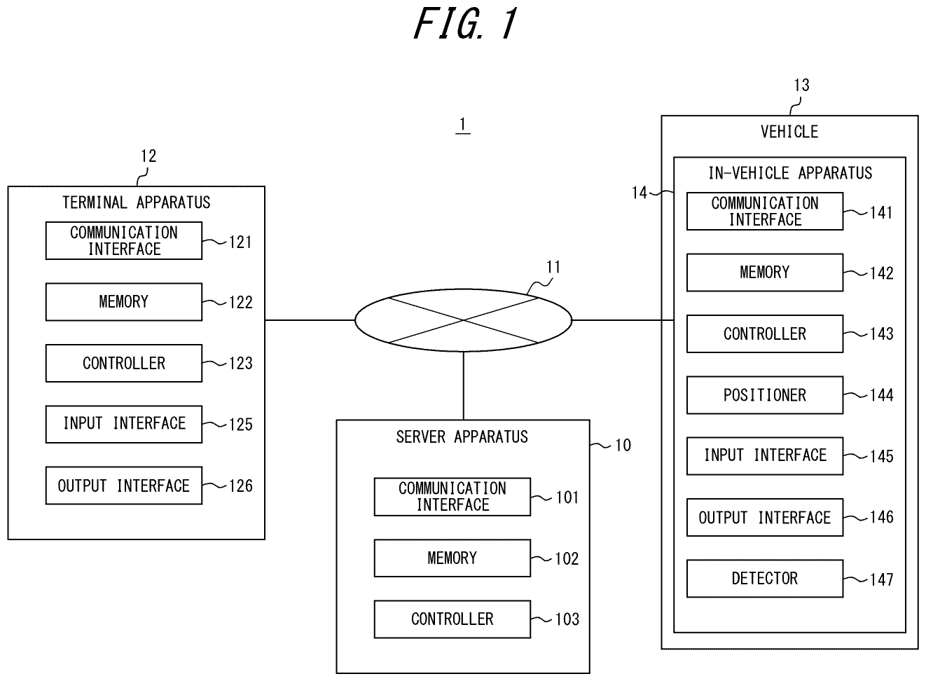

FIG. 1 is a diagram illustrating an example of a configuration of an information processing system 1 according to the embodiment. The information processing system 1 includes at least one server apparatus 10, at least one terminal apparatus 12, and at least one in-vehicle apparatus 14 mounted in a vehicle 13 that are communicably connected to each other via a network 11. The server apparatus 10 is, for example, a server computer that belongs to a cloud computing system or another computing system and functions as a server that implements various functions. The terminal apparatus 12 is an information processing terminal used by car dealership sales staff who offer vehicles 13 for test drives, and exchanges various information with the server apparatus 10. The terminal apparatus 12 is, for example, a personal computer, a tablet terminal apparatus, or the like. The vehicle 13 is, for example, a passenger car or commercial vehicle, which is offered for test drive for sales or monitoring purposes. The in-vehicle apparatus 14 has communication and information processing functions, for example, a navigation system. The network 11 may, for example, be the Internet or may include an ad hoc network, a local area network (LAN), a metropolitan area network (MAN), other networks, or any combination thereof.

In the present embodiment, the server apparatus 10 as an “information processing apparatus” acquires information on the number of times an operation has been performed by a user on equipment of the vehicle 13 for a test drive, selects equipment having a predetermined difference between the number of times the operation has been performed and a reference value (hereinafter referred to as “target equipment”), and outputs question information with respect to the target equipment. The equipment of the vehicle 13 includes equipment related to the driving support of the vehicle 13, such as navigation systems, and equipment related to the interior environment and entertainment of the vehicle 13, such as multimedia, air conditioning, sound, and lighting. Equipment may include equipment related to the operation of the vehicle 13, such as gas pedal, brake, steering, etc. Information on the number of times the operation has been performed by the user on such equipment is acquired by the in-vehicle apparatus 14, for example, and transmitted to the server apparatus 10. Among the equipment of the vehicle 13, the target equipment whose number of times the operation has been performed by the user is significantly above or below the reference value is considered to have a high probability of being worse or better than expected in terms of usability by the user. By focusing on asking users questions about such target equipment, we can expect to obtain user responses that can be used to improve the equipment of the vehicle 13. The question information is sent, for example, from the server apparatus 10 to the terminal apparatus 12, where the questions are presented and the responses are collected. According to such an embodiment, it is possible to more effectively collect responses from users who have test-driven the vehicle 13.

### <Configuration of Server Apparatus 10>

The server apparatus 10 includes a communication interface 101, a memory 102, and a controller 103. The server apparatus 10 is, for example, a single computer. The server apparatus 10 may be two or more computers that are communicably connected to each other and operate in cooperation. In this case, the configuration illustrated in FIG. 1 can be arranged among two or more computers as appropriate.

The communication interface 101 includes one or more interfaces for communication. The interfaces for communication include, for example, a LAN interface. The communication interface 101 receives information to be used for operations of the server apparatus 10 and transmits information obtained by the operations of the server apparatus 10. The server apparatus 10 is connected to the network 11 by the communication interface 101 and communicates information with the terminal apparatus 12 and the vehicle 13 via the network 11. In the server apparatus 10, the communication interface 101 acquires information on the number of times the operation has been performed by the user on equipment of the vehicle 13 from the in-vehicle apparatus 14 as a “communication interface”.

The memory 102 includes, for example, one or more semiconductor memories, one or more magnetic memories, one or more optical memories, or a combination of at least two of these types, to function as main memory, auxiliary memory, or cache memory. The semiconductor memories are, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processors are general purpose processors, such as central processing units (CPUs), or dedicated processors, such as graphics processing units (GPUs), specialized for particular processes. The dedicated circuits are, for example, field-programmable gate arrays (FPGAs), application specific integrated circuits (ASICs), or the like. The controller 103 executes information processing related to the operations of the server apparatus 10 while controlling the components of the server apparatus 10.

The functions of the server apparatus 10 are realized by execution of a control program by a processor included in the controller 103. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

### <Configuration of Terminal Apparatus 12>

The terminal apparatus 12 includes a communication interface 121, a memory 122, a controller 123, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121, and communicates information with other apparatuses over the network 11.

The memory 122 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of operations of the terminal apparatus 12 by operating according to control/processing programs or operating according to operating procedures implemented in the form of circuits. The controller 123 then transmits and receives various types of information to and from the server apparatus 10 and the like via the communication interface 121, to execute operations according to the present embodiment.

The input interface 125 includes one or more interfaces for input. The interface for input is, for example, a physical key, a capacitive key, a pointing device, a touch screen integrally provided with the display, a camera that captures images or image codes, or an IC card reader. The interface for input may include a microphone that accepts audio input. The input interface 125 accepts input of information to be used in the operations of the controller 123 and transmits the input information to the controller 123.

The output interface 126 includes one or more interfaces for output. The interfaces for output include, for example, a display or a speaker. The display is, for example, a liquid crystal display (LCD) or an organic electro-luminescent (EL) display. The output interface 126 outputs information obtained by the operations of the controller 123.

The functions of the controller 123 are realized by execution of a control program by a processor included in the controller 123. The control program is a program for causing the processor to function as the controller 123. Some or all of the functions of the controller 123 may be realized by a dedicated circuit included in the controller 123.

### <Example Configuration of In-Vehicle Apparatus 14>

The in-vehicle apparatus 14 includes a communication interface 141, a memory 142, a controller 143, a positioner 144, an input interface 145, an output interface 146, and a detector 147. These components may be configured as a single control apparatus, as two or more control apparatuses, or with another apparatus such as a control apparatus and a communication device. The control apparatus includes an electronic control unit (ECU), for example. The communication device includes a data communication module (DCM), for example. The components are communicably connected to each other or to equipment in the vehicle 13, by an in-vehicle network compliant with a standard such as a controller area network (CAN).

The memory 142, the controller 143, the input interface 145, and the output interface 146 have configurations equivalent to those of the memory 122, the controller 123, the input interface 125, and the output interface 126 of the terminal apparatus 12, respectively.

The communication interface 141 includes one or more interfaces for communication. Examples of the interface for communication include an interface corresponding to mobile communication standards, such as LTE, 4G, or 5G. The communication interface 141 receives information to be used for operations of the controller 143, and transmits information obtained by the operations of the controller 143. The controller 143 connects to the network 11 using the communication interface 141 through a mobile communication base station, and communicates information with other apparatuses via the network 11.

The positioner 144 includes one or more Global Navigation Satellite System (GNSS) receivers. The GNSS includes, for example, Global Positioning System (GPS), Quasi-Zenith Satellite System (QZSS), BeiDou, Global Navigation Satellite System (GLONASS), and/or Galileo. Based on information acquired by the positioner 144, positional information for the vehicle 13 is obtained.

The detector 147 has interfaces with one or more sensors that detect states of various parts of the vehicle 13, or has the one or more sensors. Sensors include, for example, sensors that detect user operation of various equipment of the vehicle 13. The detector 147 transmits, to the controller 143, information indicating the results detected by the sensors.

The controller 143 controls each of the communication interface 141, the memory 142, the positioner 144, the input interface 145, the output interface 146, and the detector 147 while exchanging various information with these components and also controls the operation of the vehicle 13. At the time of travel of the vehicle 13, the controller 143 controls the operation of the vehicle 13 by presenting various information necessary for the operation to the driver via the output interface 146 and/or by controlling the automatic operation of the vehicle 13.

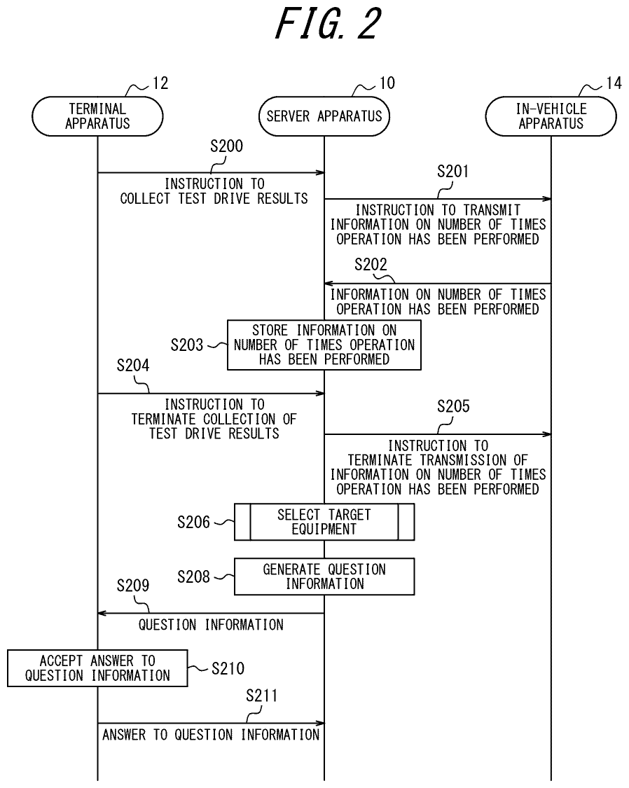

FIG. 2 is a sequence diagram illustrating an operating procedure of the information processing system 1 according to the present embodiment. FIG. 2 illustrates the steps in the coordinated operation of the server apparatus 10, the terminal apparatus 12, and the in-vehicle apparatus 14. The steps pertaining to various types of information processing by the server apparatus 10, the terminal apparatus 12, and the in-vehicle apparatus 14 in FIG. 2 are performed by the respective controllers 103, 123, and 143. The steps pertaining to transmission and reception of various types of information to and from the server apparatus 10, the terminal apparatus 12, and the in-vehicle apparatus 14 are performed by the respective controllers 103, 123, and 143 transmitting and receiving information to and from each other via the respective communication interfaces 101, 121, and 141. In the server apparatus 10, the terminal apparatus 12, and the in-vehicle apparatus 14, the respective controllers 103, 123, and 143 appropriately store the information that is transmitted and received in the respective memories 102, 122, and 142. Furthermore, the controllers 123 and 143 of the terminal apparatus 12 and the in-vehicle apparatus 14 accept input of various information from the user by the respective input interfaces 125 and 145, and output various information to the user by the respective output interfaces 126 and 146.

In S200, the terminal apparatus 12 transmits an instruction to collect test drive results to the server apparatus 10. For example, when a user starts a test drive of a vehicle 13, if an instruction to collect test drive results is input to the terminal apparatus 12 by the user or a car dealer representative, the terminal apparatus 12 transmits the instruction to collect test drive results toward the server apparatus 10.

In S201, the server apparatus 10 transmits to the in-vehicle apparatus 14 an instruction to transmit information on the number of times the operation has been performed in response to the instruction to collect test drive results. The information on the number of times the operation has been performed is information indicating the number of times the operation has been performed by the user on each piece of equipment of the vehicle 13.

In S202, the in-vehicle apparatus 14 transmits the information on the number of times the operation has been performed to the server apparatus 10 in response to the instruction to transmit the information on the number of times the operation has been performed. In the in-vehicle apparatus 14, operations on various equipment are detected by the detector 147 and transmitted to the controller 143, which counts the number of times the operation has been performed and transmits the information on the number of times the operation has been performed generated by the controller 143 toward the server apparatus 10. The information on the number of times the operation has been performed includes identification information that identifies various types of equipment and the number of times the operation has been performed that is associated with the identification information. The number of times the operation has been performed includes, for example, the number of times an operation indicating any control amount is performed on the accelerator, brake, steering wheel, air conditioning, sound, lighting, etc., and the number of times an input, selection, etc. is performed on multimedia, navigation systems, etc.

In S203, the server apparatus 10 stores the information on the number of times the operation has been performed.

In S204, the terminal apparatus 12 transmits, to the server apparatus 10, an instruction to terminate collection of test drive results. For example, when a user finishes a test drive of the vehicle 13, the user or a person in charge at the car dealer inputs instructions to the terminal apparatus 12 to terminate collection of test drive results, and the terminal apparatus 12 transmits instructions to the server apparatus 10 to terminate collection of test drive results.

In S205, the server apparatus 10 transmits an instruction to the in-vehicle apparatus 14 to terminate transmission of information on the number of times the operation has been performed in response to the instruction to terminate collection of test drive results. In response, the in-vehicle apparatus 14 terminates the transmission of the information on the number of times the operation has been performed. S202 and S203 are repeatedly executed until S204 and S205 are executed and the instruction to terminate collection of test drive results are transmitted to the in-vehicle apparatus 14.

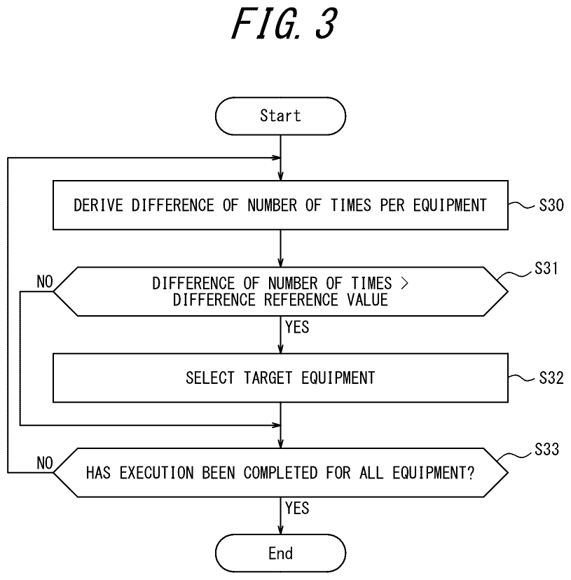

In S206, the server apparatus 10 selects the target equipment. The detailed procedure of S206 is illustrated in FIG. 3.

FIG. 3 is a flowchart illustrating an example operation procedure of the controller 103 in the server apparatus 10.

In S30, the controller 103 derives the difference (hereinafter referred to as “difference of the number of times”) between the number of times the operation has been performed and the reference value (hereinafter referred to as “reference value of the number of times”) for each equipment. The controller 103 reads the number of times the operation has been performed acquired per equipment and the reference value of the number of times previously set per equipment stored in the memory 102, and derives the difference of the number of times. Here, the difference of the number of times is the absolute value of the difference between the number of times the operation has been performed and the reference value of the number of times.

In S31, the controller 103 determines whether the difference of the number of times exceeds any reference value (hereinafter referred to as the difference reference value). If the difference of the number of times exceeds the difference reference value (Yes), the controller 103 proceeds to S32; if the difference of the number of times is less than the difference reference value (No), the controller 103 proceeds to S34.

In S32, the controller 103 selects the equipment such that the difference of the number of times exceeds the difference reference value as the target equipment. The selection results are stored in the memory 102.

In S33, the controller 103 determines whether the execution of S30 to S32 has been completed for all equipment. If the execution has been completed for all equipment (Yes), the controller 103 terminates the FIG. 3 procedure; if the execution has not been completed for all equipment (No), the controller 103 returns to S30 and executes S30-S32 for the other equipment.

Returning to FIG. 2, in S208, the server apparatus 10 generates question information. The server apparatus 10 generates question information with respect to the selected target equipment. For example, with respect to each piece of equipment, the memory 102 stores, in advance, questions when the equipment is selected as the target equipment (hereinafter referred to as “focus questions”) and questions when the equipment is other than the target equipment (hereinafter referred to as “non-target equipment”) (hereinafter referred to as “normal questions”). Key questions include more questions or more detailed questions (specifically, questions with more characters) than normal questions. The controller 103 generates question information including key questions for the target equipment. In addition to question information with respect to the target equipment, the controller 103 may generate question information including normal questions with respect to non-target equipment.

In S209, the server apparatus 10 transmits the question information with respect to the target equipment, or in addition to this, the question information with respect to the non-target equipment, to the terminal apparatus 12.

In S210, the terminal apparatus 12 accepts answers to the question information. The terminal apparatus 12 outputs question information and accepts user input of answers to each question. The question information includes focused or normal questions with respect to each piece of equipment, depending on whether the equipment is targeted or non-targeted equipment. The user can answer each question based on his/her subjectivity after the test drive.

In S211, the terminal apparatus 12 transmits information on the answers to the question information to the server apparatus 10. The server apparatus 10 stores the answers tied to the questions for each piece of equipment. The question information may be transmitted to the in-vehicle apparatus 14 in S209, the answer may be accepted by the in-vehicle apparatus 14 in S210, and the answer may be transmitted to the server apparatus 10 in S211.

The answers collected in this procedure are acquired from the server apparatus 10 by the terminal apparatus 12 or other apparatuses as appropriate, and are used to develop and improve the equipment of the vehicle 13. In particular, more detailed answers can be collected with respect to the target equipment through focused questions.

In a variation of S208, the server apparatus 10 may generate question information with even more questions or more detailed questions if the number of times the operation has been performed on the target equipment is below any minimum reference value. The memory 102 stores in advance high priority questions that have a greater number of questions or a greater number of characters than the priority questions, and the controller 103 can generate question information using such high priority questions.

In a further variation, the server apparatus 10 adjusts the reference value of the number of times per equipment, for example, after S211. For example, the server apparatus 10 performs the FIG. 2 and FIG. 3 procedures for multiple vehicles 13 to collect information on the number of times the operation has been performed per equipment with respect to each of the multiple vehicles 13. The server apparatus 10 can then derive the average of the number of times the operation has been performed acquired in the multiple vehicles 13 for each piece of equipment, and use as a new reference value of the number of times a value closer to the operation reference value obtained by dividing the average of the number of times the operation has been performed by any factor (e.g., less than 0.5). In this way, it is possible to adjust the operation reference value per equipment so that the difference of the number of times is not too large, i.e., a value that better fits the tendencies of multiple users.

In the embodiment described above, some or all of the operations of the server apparatus 10 may be performed by the terminal apparatus 12. In that case, the “information processing apparatus” may be configured by the server apparatus 10 and the terminal apparatus 12, or by the terminal apparatus 12 alone, and the communication interface 121 of the terminal apparatus 12 may function as the “acquisition interface”. The in-vehicle apparatus 14 may also serve as the terminal apparatus 12. In that case, the procedures by the terminal apparatus 12 of the operating procedures in FIG. 2 and FIG. 3 may be performed by the in-vehicle apparatus 14, and the detector 147 of the in-vehicle apparatus 14 may function as the “acquisition interface”.

According to the embodiment described above, it is possible to more effectively collect responses from users who have test-driven the vehicle 13.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising:
an acquisition interface configured to acquire information on a number of times an operation has been performed by a user on equipment of a vehicle for a test drive; and
a controller configured to select first equipment having a predetermined difference between the number of times the operation has been performed and a reference value, and output first question information with respect to the first equipment.

2. The information processing apparatus according to claim 1, wherein the controller is configured to output, with respect to second equipment having a difference between the number of times the operation has been performed and the reference value smaller than the difference in a case of the first equipment, second question information in which a number of questions or a number of characters in each question is smaller than the first question information.

3. The information processing apparatus according to claim 1, wherein the controller is configured to increase a number of questions or increase a number of characters in each question in the first question information in a case in which a number of times the operation has been performed on the first equipment is smaller than a reference number of times the operation is to be performed.

4. The information processing apparatus according to claim 1, wherein the controller is configured to change the reference value for the first equipment based on information on an answer to the first question information.

5. An operating method of an information processing apparatus comprising:
acquiring information on a number of times an operation has been performed by a user on equipment of a vehicle for a test drive; and
selecting first equipment having a predetermined difference between the number of times the operation has been performed and a reference value, and outputting first question information with respect to the first equipment.
